(19) United States
(12) Patent Application Publication
(10) Pub. No.: US 2026/0081845 A1
(43) Pub. Date: Mar. 19, 2026

(54) Methods For Supporting Associated IDs for Multi-TRPs

(71) Applicant: InterDigital Patent Holdings, Inc., Wilmington, DE (US)

(72) Inventors: Young Woo Kwak, Woodbury, NY (US); Oumer Teyeb, Montreal (CA); Moon IL Lee, Melville, NY (US); Dylan Watts, Montreal (CA); Haseeb Ur Rehman, Winnipeg (CA)

(73) Assignee: InterDigital Patent Holdings, Inc., Wilmington, DE (US)

(21) Appl. No.: 18/889,007

(22) Filed: Sep. 18, 2024

(51) Int. Cl. H04L 41/16; H04W 24/02; H04W 48/16

(52) U.S. Cl. CPC H04L 41/16; H04W 24/02; H04W 48/16

(57) ABSTRACT

A WTRU comprising a processor is provided. The processor is configured to receive a configuration of an associated ID and a set of sub-associated IDs related to the associated ID. The associated ID represents a network condition. Each of the set of sub-associated IDs represents at least one of a functionality or a transmission scenario. The processor is further configured to determine applicability of the associated ID based on the configuration. The determined applicability corresponds to full applicability based on the associated ID being applicable for each of the set of sub-associated IDs. The applicability corresponds to partial applicability based on the associated ID being applicable for at least one of the set of sub-associated IDs. The processor is further configured to apply the associated ID to perform at least one of the functionality or the transmission scenario based on the determined applicability.

### BACKGROUND

New radio (NR) air interfaces may employ artificial intelligence (AI)/machine learning (ML). Model identification and data collection related configurations can be used to support model identification via over-the-air signaling.

### SUMMARY

A Wireless Transmit/Receive Unit (WTRU) comprising a processor is provided. The processor is configured to receive configuration information indicating of an associated identifier (ID) and a set of sub-associated IDs related to the associated ID. The associated ID represents a network condition. Each of the set of sub-associated IDs represents at least one of a functionality or a transmission scenario. The processor is further configured to determine applicability of the associated ID based on the configuration information. The determined applicability corresponds to full applicability based on the associated ID being applicable for each of the set of sub-associated IDs. The applicability corresponds to partial applicability based on the associated ID being applicable for at least one of the set of sub-associated IDs. The processor is further configured to apply the associated ID to perform at least one of the functionality or the transmission scenario based on the determined applicability.

In examples, the processor is further configured to receive an activation message of the associated ID and determine the applicability in response to receipt of the activation message. In examples, a first sub-associated ID of the set of sub-associated IDs represents the network condition for a first transmit-receive-point (TRP) and a second sub-associated ID of the set of sub-associated IDs represents the network condition for a second TRP. In examples, the configuration information includes an indication of a second associated ID and a second set of sub-associated IDs. In examples, the processor is further configured to send an indication of an applicability of one or more sub-associated IDs with respect to one or more artificial intelligence/machine learning (AIML) models at the WTRU. In examples, the processor is further configured to determine that the associated ID is partially applicable based on a number of applicable sub-associated IDs being greater than a threshold. In examples, the processor is further configured to evaluate performance of an AIML model with respect to the set of sub-associated IDs. In examples, the processor is further configured to determine that the AIML model is applicable with respect to a first sub-associated ID based on the evaluated performance being greater than a performance threshold. In examples, the processor is further configured to apply the AIML model for the functionality and the transmission scenario based on the applicability corresponding to full applicability. In examples, the processor is further configured to apply the AIML model for one of the functionality or the transmission scenario based on the applicability corresponding to partial applicability. In examples, a first sub-associated ID of the set of sub-associated IDs represents a first configuration for training the AIML model and a second sub-associated ID of the set of sub-associated IDs represents a second configuration for inference using the AIML model. In examples, a first sub-associated ID of the set of sub-associated IDs corresponds to a first AIML model, and a second sub-associated ID of the set of sub-associated IDs corresponds to a second AIML model at the WTRU.

A method performed by a WTRU is provided. The method comprises receiving configuration information indicating an associated identifier (ID) and a set of sub-associated IDs related to the associated ID. The associated ID represents a network condition. Each of the set of sub-associated IDs represents at least one of a functionality or a transmission scenario. The method further comprises sending the context information. The method further comprises determining applicability of the associated ID based on the configuration information. The determined applicability corresponds to full applicability based on the associated ID being applicable for each of the one or more sub-associated IDs. The applicability corresponds to partial applicability based on the associated ID being applicable for at least one of the set of sub-associated IDs. The method further comprises applying the associated ID to perform at least one of the functionality or the transmission scenario based on the determined applicability.

In examples, the method further comprises receiving an activation message of the associated ID and determining the applicability in response to receipt of the activation message. In examples, a first sub-associated ID of the set of sub-associated IDs represents the network condition for a first transmit-receive-point (TRP) and a second sub-associated ID of the set of sub-associated IDs represents the network condition for a second TRP. In examples, the configuration information includes an indication of a second associated ID and a second set of sub-associated IDs. In examples, the method further comprises sending an indication of an applicability of one or more sub-associated IDs with respect to one or more AIML models at the WTRU. In examples, the method further comprises determining that the associated ID is partially applicable based on a number of applicable sub-associated IDs being greater than a threshold. In examples, the method further comprises evaluating performance of an AIML model with respect to the set of sub-associated IDs. In examples, the method further comprises determining that the AIML model is applicable with respect to a first sub-associated ID based on the evaluated performance being greater than a performance threshold. In examples, the method further comprises applying the AIML model for the functionality and the transmission scenario based on the applicability corresponding to full applicability. In examples, the method further comprises applying the AIML model for one of the functionality or the transmission scenario based on the applicability corresponding to partial applicability. In examples, a first sub-associated ID of the set of sub-associated IDs represents a first configuration for training the AIML model and a second sub-associated ID of the set of sub-associated IDs represents a second configuration for inference using the AIML model. In examples, a first sub-associated ID of the set of sub-associated IDs corresponds to a first AIML model, and a second sub-associated ID of the set of sub-associated IDs corresponds to a second AIML model at the WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### DETAILED DESCRIPTION

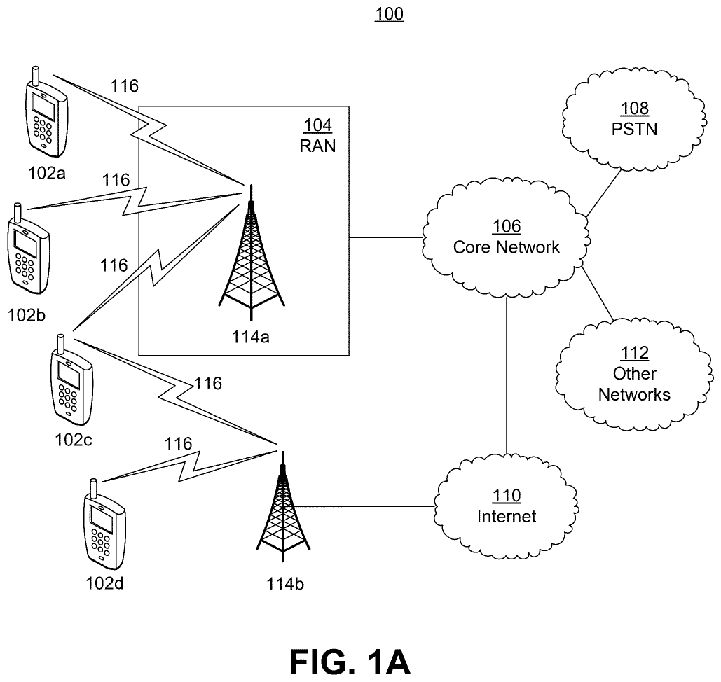

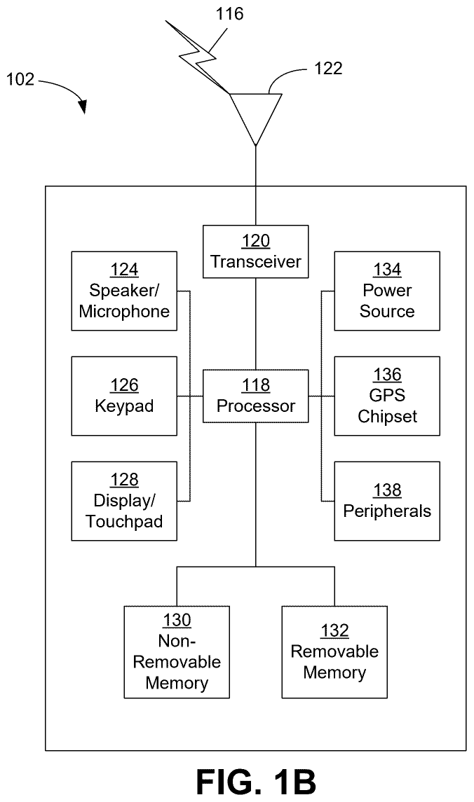

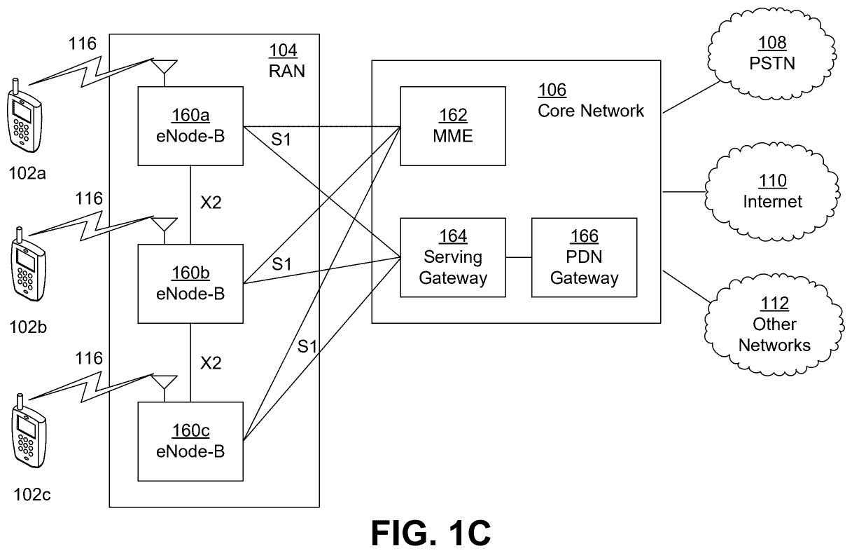

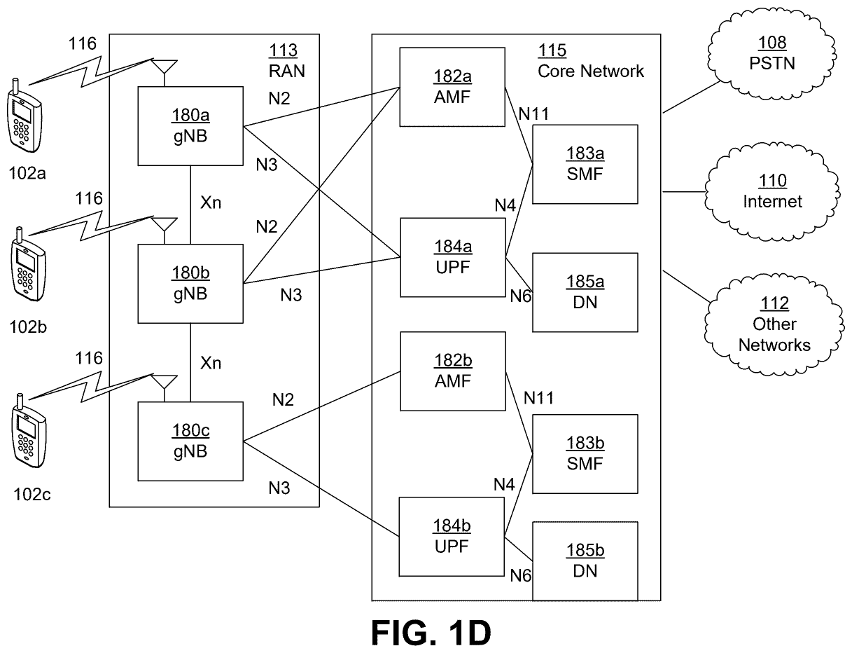

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The present disclosure includes an example AI/ML general framework for one-sided AI/ML models. Example signaling and protocol aspects of Life Cycle Management (LCM) enabling functionality and model (e.g., if justified) selection, activation, deactivation, switching, fallback are described herein. Examples of identification related signaling in line with the discussion above are described herein. Examples described herein include signaling/mechanism(s) for LCM to facilitate model training, inference, performance monitoring, data collection (e.g., including data collection for purposes other the purpose of CN/OAM/OTT collection of WTRU-sided model training data) for both WTRU-sided and NW-sided models. Examples of signaling mechanism of applicable functionalities and/or models are described herein. Examples are described herein for how to identify AI/ML model as well as applicable functionalities/models and support LCM for supporting AI/ML model in NR.

Model identification with data collection related configuration(s) and/or indication(s) can be used to support model identification procedure via over-the-air signaling. For instance, associate ID(s) can be used for consistency of NW side additional conditions across training and inference of WTRU side model. Examples are described herein for achieving consistency of NW side additional conditions for multiple transmission reception points (TRPs). For example, a procedure is described herein to identify whether the whole TRPs, transmission scenarios and/or functionalities are supported for equipped AI/ML models (e.g., or not) should be supported. If only a subset of TRPs, transmission scenarios or functionalities are supported for the WTRU, examples are described herein for handling (e.g., or deciding) the partial applicability (e.g., of the AI/ML models). Additionally or alternatively, unlike managing a cell with a single TRP, a single functionality or a single transmission scenario, examples are described herein that enable an enhanced life cycle management mechanism for handling multiple TRPs, multiple functionalities and/or multiple transmission scenarios.

Typically, current configurations that involve associated ID(s) may be suitable for a simple scenario in which a single TRP is considered. However, the benefit of AI/ML models increases in scenarios where complexity of a problem that needs to be solved increases. For instance, more complex transmission scenarios including dynamic point selection (DPS) and joint transmission (JT) may benefit if the support of associated ID(s) is available. Accordingly, the present disclosure provides examples that enable achieving WTRU consistency of NW side additional conditions for multiple TRPs (e.g., and/or for other complex transmission scenarios).

A WTRU may determine applicability of an associated ID based on sub-associated IDs. The WTRU may support AI/ML based on the determined applicability.

The WTRU may receive a configuration of one or more associated IDs and one or more sub-associated IDs. Each associated ID may be associated with a set of sub-associated IDs. Each sub-associated ID may represent one of each TRP, functionality (e.g., reference signal (RS) configuration, channel, gNB traffic, etc.), and/or transmission scenario. As an example of TRP specific associated IDs, a first associated ID (e.g., associated ID #1) may be associated with a sub-associated ID for a first TRP (e.g., TRP #1) and a sub-associated ID for a second TRP (e.g., TRP #2). In this example, a second associated ID (e.g., associated ID #2) may be associated with a sub-associated ID for the first TRP (e.g., TRP #1) and a sub-associated ID for a third TRP (e.g., TRP #3).

The WTRU may indicate WTRU applicability and/or capability of the one or more sub-associated IDs. For example, a first sub-associated ID (e.g., ID #1) may be indicated as being applicable, and a second sub-associated ID (e.g., ID #2) may be indicated as not applicable. In some examples, the applicability of a given sub-associated ID may be updated (e.g., changed) dynamically.

The WTRU may receive an activation message of an associated ID.

The WTRU may determine applicability of a WTRU model based on the configuration. For example, the WTRU may determine the model is fully applicable if all sub-associated IDs associated with the indicated associated ID are applicable. As another example, the WTRU may determine the model is partially applicable if one or more conditions are satisfied.

A first example condition may be if number of applicable sub-associated IDs of the indicated associated ID is greater than a sub-associated ID threshold, then the WTRU may determine the model is partially applicable. Otherwise, the model may be deemed not applicable.

A second example condition may include the WTRU evaluating performance of the AI/ML model (e.g., by evaluating performance of AI/ML model prediction). If the performance is greater than a performance threshold, the WTRU may determine the model is partially applicable. Otherwise, the model may be deemed not applicable. Alternatively or additionally, the WTRU may receive a configuration related with evaluation (e.g., one or more evaluation types and/or evaluation parameters) such as RS config/duration/timer. Accordingly, for example, the WTRU may evaluate performance of the AIML model with respect to the set of sub-associated IDs, and determine that the AIML model is applicable with respect to a first sub-associated ID based on the evaluated performance being greater than a performance threshold.

The WTRU may support AI/ML model based on the determined applicability. For example, if the model is fully applicable (or partially applicable), the WTRU may apply the AI/ML model for all the associated functionality/transmission scenarios. Alternatively or additionally, if the model is partially applicable, the WTRU may apply the AI/ML model only for the applicable functionality/transmission scenario(s) (e.g., switching between AI/ML and non-AI/ML). If the model is not applicable, the WTRU may apply non-AI/ML mode. Accordingly, for example, the WTRU may apply the AIML model for the functionality and the transmission scenario based on the applicability corresponding to full applicability, and apply the AIML model for one of the functionality or the transmission scenario based on the applicability corresponding to partial applicability.

Advantageously, the proposed solution described herein may enable the WTRU to identify whether a given scenario is fully applicable, partially applicable, and/or not applicable based on given sub-associated IDs and supported AI/ML model(s) accordingly.

Hereinafter, ‘a’, ‘an’ and similar phrases may be interpreted as ‘one or more’ and/or ‘at least one’. Similarly, any term which ends with the suffix ‘(s)’ may be interpreted as ‘one or more’ and/or ‘at least one’. The term ‘may’ may be interpreted as ‘may, for example’.

Hereinafter, the term “artificial intelligence” (AI) may be broadly defined as the behavior exhibited by machines. Such behavior may, e.g., mimic cognitive functions to sense, reason, adapt and act. Machine learning (ML) may refer to algorithms that solve a problem based on learning through experience (e.g., ‘data’), without explicitly being programmed (e.g., ‘configuring set of rules’). Machine learning can be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some solutions, it is possible to apply machine learning algorithms using a combination or interpolation of the above-mentioned approaches. For example, a semi-supervised learning approach may use a combination of a small amount of labeled data with a large amount of unlabeled data during training. In this regard semi-supervised learning falls between unsupervised learning (with no labeled training data) and supervised learning (with only labeled training data). Deep learning (DL) may refer to a class of machine learning algorithms that employ artificial neural networks (e.g., deep neural networks (DNNs)) which were loosely inspired from biological systems. Deep Neural Networks (DNNs) are a special class of machine learning models inspired by human brain wherein the input is linearly transformed and pass-through non-linear activation function multiple times. DNNs typically consists of multiple layers where each layer consists of linear transformation and a given non-linear activation functions. The DNNs can be trained using the training data via back-propagation algorithm. Recently, DNNs have shown state-of-the-art performance in a variety of domains, e.g., speech, vision, natural language, etc., and for various machine learning settings e.g., supervised, un-supervised, and/or semi-supervised. The term AIML based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

Examples described herein may include a definition of Beam. A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving a reference signal (RS) (e.g., channel state information reference signal (CSI-RS)) or a synchronization signal (SS) block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC or signaled by MAC CE or DCI. For example, a UE may implicitly transmit physical uplink shared channel (PUSCH) and demodulation reference signal (DM-RS) of PUSCH according to the same spatial domain filter as a sounding reference signal (SRS) indicated by an SRS resource indicator (SRI) indicated in DCI or configured by RRC. In another example, a spatial relation may be configured by RRC for an SRS resource indicator (SRI) or signaled by MAC CE for a physical uplink control channel (PUCCH). Such spatial relation may also be referred to as a “beam indication”.

The WTRU may receive a first (e.g., target) downlink channel or signal according to the same spatial domain filter or spatial reception parameter as a second (reference) downlink channel or signal. For example, such association may exist between a physical channel such as physical downlink control channel (PDCCH) or physical downlink shared channel (PDSCH) and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of transmission configuration indicator (TCI) states configured by RRC and/or signaled by MAC CE. Such indication may also be referred to as a “beam indication.”

Examples are described herein for transmission reception point (TRP), multiple TRP (MTRP), and/or multi-TRP (M-TRP). Hereafter, the term TRP may be interchangeably used with one or more of transmission point (TP), reception point (RP), RRH (radio remote head), distributed antenna (DA), base station (BS), a sector (e.g., of a BS), and/or a cell (e.g., a geographical cell area served by a BS), without departing from the scope of the present disclosure. Hereafter, the term “Multi-TRP” may be interchangeably used with one or more of MTRP, M-TRP, and multiple TRPs, without departing from the scope of the present disclosure.

Example CSI components are described herein. A WTRU may report a subset of channel state information (CSI) components, where CSI components may correspond to at least a CSI-RS resource indicator (CRI), a synchronization signal block (SSB) resource indicator (SSBRI), an indication of a panel used for reception at the WTRU (e.g., a panel identity or group identity), measurements such as layer 1 reference signal received power (L1-RSRP), layer 1 signal to interference noise ratio (L1-SINR) taken from SSB or CSI-RS (e.g., cri-RSRP, cri-SINR, ssb-Index-RSRP, ssb-Index-SINR), and/or other channel state information such as at least one of a rank indicator (RI), channel quality indicator (CQI), precoding matrix indicator (PMI), Layer Index (LI), and/or the like.

Examples are described herein for Channel and/or Interference Measurements.

A WTRU may receive a synchronization signal/physical broadcast channel (SS/PBCH) block. The SS/PBCH block (SSB) may include a primary synchronization signal (PSS), secondary synchronization signal (SSS), and/or a physical broadcast channel (PBCH). The UE may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may include or be configured with a CSI report configuration, CSI-RS resource set including one or more CSI resource settings, and/or non-zero-power (NZP) CSI-RS resources. The CSI Report Configuration may include CSI report quantity (e.g., Channel Quality Indicator (CQI), Rank Indicator (RI), Precoding Matrix Indicator (PMI), CSI-RS Resource Indicator (CRI), Layer Indicator (LI), etc.), CSI report type (e.g., aperiodic, semi persistent, periodic), CSI report codebook configuration (e.g., Type I, Type II, Type II port selection, etc., and/or CSI report frequency. The CSI Resource settings may include NZP-CSI-RS Resource for channel measurement, NZP-CSI-RS Resource for interference measurement, and/or CSI-IM Resource for interference measurement. The NZP CSI-RS may include NZP CSI-RS Resource ID, Periodicity and offset, QCL Info and TCI-state, and/or Resource mapping, e.g., number of ports, density, CDM type, etc.

A WTRU may indicate, determine, or be configured with one or more reference signals. The WTRU may monitor, receive, and measure one or more parameters based on the respective reference signals. The following parameters are non-limiting examples of the parameters that may be included in reference signal(s) measurements. One or more of these parameters may be included.

The one or more parameters may include SS reference signal received power (SS-RSRP). SS-RSRP may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

The one or more parameters may include CSI-RSRP. CSI-RSRP may be measured based on the linear average over the power contribution of the resource elements (RE) that carry the respective CSI-RS. The CSI-RSRP measurement may be configured within measurement resources for the configured CSI-RS occasions.

The one or more parameters may include SS-SINR. SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

The one or more parameters may include CSI-SINR. CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

The one or more parameters may include RSSI. Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth)

The one or more parameters may include CLI-RSSI. Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth)

The one or more parameters may include SRS-RSRP. Sounding reference signals RSRP (SRS-RSRP) may be measured based on the linear average over the power contribution of the resource elements (RE) that carry the respective SRS.

Examples are described herein for Beam/CSI Report Configuration. A CSI report configuration (e.g., CSI-ReportConfigs) may be associated with a single bandwidth part (BWP) (e.g., indicated by BWP-Id), wherein one or more of parameters are configured. The one or more parameters may include one or more of CSI-RS resources and/or CSI-RS resource sets for channel and interference measurement, CSI-RS report configuration type (e.g., periodic, semi-persistent, aperiodic), CSI-RS transmission periodicity for periodic and semi-persistent CSI reports, CSI-RS transmission slot offset for periodic, semi-persistent and aperiodic CSI reports, CSI-RS transmission slot offset list for semi-persistent and aperiodic CSI reports, time restrictions for channel and interference measurements, report frequency band configuration (e.g., wideband/subband CQI, PMI, and so forth), Thresholds and modes of calculations for the reporting quantities (CQI, RSRP, SINR, LI, RI, etc.), Codebook configuration, Group based beam reporting, CQI table, Subband size, Non-PMI port indication, Port Index, etc.

Examples are described herein for CSI-RS Resource Configuration. A CSI-RS Resource Set (e.g., NZP-CSI-RS-ResourceSet) may include one or more of CSI-RS resources (e.g., NZP-CSI-RS-Resource and CSI-ResourceConfig). For example, a WTRU may be configured (e.g., in a CSI-RS Resource) with one or more of: CSI-RS periodicity and slot offset for periodic and semi-persistent CSI-RS Resources; CSI-RS resource mapping to define the number of CSI-RS ports, density, CDM-type, OFDM symbol, and subcarrier occupancy; the bandwidth part to which the configured CSI-RS is allocated; and/or the reference to the TCI-State including the QCL source RS(s) and the corresponding QCL type(s).

Examples are described herein RS resource set Configuration. One or more configurations may be used for RS resource set. For example, a WTRU may be configured with one or more RS resource sets. The RS resource set configuration may include one or more of RS resource set ID, one or more RS resources for the RS resource set, repetition (i.e., on or off), aperiodic triggering offset (e.g., one of 0-6 slots), and/or tracking reference signal (TRS) information (e.g., true or not).

Examples are described herein for RS resource Configuration. One or more configurations may be used for RS resource. For example, a WTRU may be configured with one or more RS resources. The RS resource configuration may include one or more of: RS resource ID, Resource mapping (e.g., REs in a physical resource block (PRB)), power control offset (e.g., a value from −8, . . . , 15), power control offset with SS (e.g., −3 dB, 0 dB, 3 dB, 6 dB), Scrambling ID, periodicity and offset, and/or QCL information (e.g., based on a TCI state).

Examples for property of a grant or assignment are described herein. For example, a property of a grant or assignment may include at least one of: a frequency allocation, an aspect of time allocation (e.g., a duration, a priority, a modulation, and/or coding scheme), a transport block size, a number of spatial layers, a number of transports blocks, a TCI state (e.g., CRI or SRI), a number of repetitions, an indication of whether the repetition scheme is Type A or Type B, an indication of whether the grant is a configured grant type 1, type 2 or a dynamic grant, an indication of whether the assignment is a dynamic assignment or a semi-persistent scheduling (e.g., configured) assignment, a configured grant index or a semi-persistent assignment index, a periodicity of a configured grant or assignment, a channel access priority class (CAPC), and/or any parameter provided in a DCI, by MAC, by LPP or by RRC for the scheduling the grant or assignment.

An indication by DCI may include at least one of an explicit indication or an implicit indication. The explicit indication may be by a DCI field or by RNTI used to mask CRC of the PDCCH. The implicit indication may be by a property such as DCI format, DCI size, Coreset or search space, Aggregation Level, and/or first resource element of the received DCI (e.g., index of first Control Channel Element). The mapping between the property and the value may be signaled by RRC or MAC.

Hereafter, the term RS may be interchangeably used with one or more of RS resource, RS resource set, RS port and RS port group, without departing from the scope of the present disclosure. Hereafter, the term RS may be interchangeably used with one or more of SSB, CSI-RS, SRS, DM-RS, TRS, PRS, and PTRS, without departing from the scope of the present disclosure. Hereafter, a reference signal may be interchangeably used with one or more of sounding reference signal (SRS), channel state information-reference signal (CSI-RS), demodulation reference signal (DM-RS), phase tracking reference signal (PT-RS), and/or synchronization signal block (SSB), without departing from the scope of the present disclosure.

Hereafter, the term channel may be interchangeably used with one or more of: PDCCH, PDSCH, physical uplink control channel (PUCCH), physical uplink shared channel (PUSCH), physical random access channel (PRACH), etc., without departing from the scope of the present disclosure.

A key performance indicator (KPI) may refer to, but not limited to, one or more of: signal quality (e.g., L1-RSRP, SINR, CQI, RSSI, RSRQ), prediction performance (e.g., Percentage of the Top-1 genie-aided (i.e., best) beam is one of the Top-K predicted beams), link quality (e.g., throughput, block error rate (BLER)), data distribution (e.g., mean and/or variance of measured and/or predicted beam measurements), and/or RSRP (e.g., L1-RSRP) difference (e.g., the difference between measured and predicted RSRP of a beam).

Hereafter, a signal, channel, and/or message (e.g., as in DL or UL signal, channel, and message) may be used interchangeably, without departing from the scope of the present disclosure.

Hereafter, a RS resource set may be interchangeably used with a RS resource and/or a beam group, without departing from the scope of the present disclosure.

Hereafter, beam reporting may be interchangeably used with CSI measurement, CSI reporting and/or beam measurement, without departing from the scope of the present disclosure.

Hereafter, the proposed solutions for beam resources prediction may be used for beam resources belonging to a single or multiple cells as well as single or multiple TRPs, without departing from the scope of the present disclosure.

Hereafter, CSI reporting may be interchangeably used with CSI measurement, beam reporting and beam measurement, without departing from the scope of the present disclosure.

Hereafter, a Set B may be interchangeably used with a set of RS resource sets, beams, beam-pairs, beam RS resources, RS resources, and/or a beam pattern.

Hereafter, Set B may be interchangeably used with measurement RS resources, measurement RS resource set, measurement beam resources, measurement beam resource set, measurement beam pattern, measurement TCI states, measurement TCI state group, etc., without departing from the scope of the present disclosure.

Hereafter, a Set A may be interchangeably used with a set of RS resource sets, beams, beam-pairs, beam RS resources, RS resources, and/or a beam pattern.

Hereafter beam prediction accuracy may be interchangeably used with prediction accuracy, without departing from the scope of the present disclosure.

Examples are described herein for WTRU capability and related aspects. For example, the WTRU may be configured to support some WTRU capability communication between the WTRU and the network about an AIML capability (e.g., where the WTRU can indicate to the network the supported AIML models/functions, confidence level of predictions, time horizon of predictions or how far in the future are the predictions being made, etc.) of the WTRU.

The WTRU may support several AIML models for a certain functionality (e.g., with different prediction time horizons, prediction confidence levels, processing requirements, trained under/for operation in different frequencies/cells/location/times of day, etc.).

A given AIML model can operate in different modes (e.g., with different levels of prediction confidence levels at different prediction time horizons, at different locations, frequencies, WTRU mobility pattern/speed, etc.).

The AIML models can be available at the WTRU already trained, or the WTRU may be provided with an untrained AIML model and performs the training by itself. The AIML model may be available at the WTRU already trained, and the WTRU may be enabled/configured to perform further training (e.g., for different conditions such as frequencies/cells/location/times of day, for the same conditions as the initial training but for increasing the level of confidence or/and the prediction time horizon, for different UE speeds, etc.). The AIML model may be available at the WTRU but not trained or trained for certain WTRU/network conditions, and the WTRU may be configured to train the model (e.g. for the conditions that it is not trained for).

In some cases, the WTRU may require some configurations/inputs for performing inference using an AIML model. For example, for beam prediction, the WTRU may need to be configured with a certain number of beams to measure to measure other beams (e.g., set A/B configuration referred to above). In some cases, the WTRU may communicate the required configuration/input as part of the capability information. In other cases, the required configuration/input may be communicated to the network after capability request (e.g., based on explicit network request if the WTRU gets configured to do AIML based BM operations and the WTRU has determined that it is lacking the required configuration/input, etc.).

A given AIML functionality may be associated with a set of KPI or metrics. A non-exhaustive list of example KPI or metrics includes prediction accuracy, average or mean square difference between measured and predicted values, etc. As an example for beam prediction, the KPI or metrics may include beam prediction accuracy and/or confidence level, L1 RSRP difference between the measured and predicted beam signal levels, etc. A WTRU may have one or more AIML models for a given functionality, and each may have performance levels that meet different KPI thresholds (e.g., UE may have 2 models, where one has an accuracy level of 90% and another one with an accuracy level of 95%, etc.,) and it may inform the network during its capability reporting or after the capability reporting.

Examples are described herein for consistency between training and inference. A given AIML model may be trained under certain WTRU and network side additional conditions. For example, a WTRU side condition could be the speed of the WTRU. On the other hand, network side additional conditions related to network configurations/settings that the WTRU may not be aware of may impact the performance of the model. For example, an AIML beam management model may perform differently if it is trained when the network was using a certain antenna pattern, beam pattern, power levels, and so on. Aspects related to network load may also have an impact on the model performance.

Since the WTRU doesn't necessarily need to know all the details of network side additional conditions (and/or network may not expose some of these details), the network could hide these details by signaling to the WTRU one or more associated ID(s). For example, when data is being collected for training a model, tagging may be performed indicating under which network side additional conditions the model is being trained. When a WTRU is being configured to perform an AIML operation, it may be configured to check the consistency between the conditions under which the AIML model is trained and current conditions (e.g., current WTRU conditions, current associated ID(s) signaled by the network indicating current network conditions/settings, etc.).

In some examples, the full or partial validity/applicability of an associated ID may indicate whether a WTRU has an AIML model/functionality that is valid/applicable for the associated ID. For example, the network may signal the same associated ID(s) to multiple WTRUs. In this example, a first WTRU may determine that the associated ID(s) to be fully applicable, a second WTRU may determine the associated ID(s) to be partially applicable, and a third WTRU may determine the associated ID(s) to be not applicable.

Examples are described herein for Life Cycle Management (LCM). The term Life cycle management (LCM) may be used herein to describe (e.g., overall) management aspects of AI/ML models, such as model training, functionality/model identification, model delivery/transfer, model inference operation, functionality/model selection, activation, deactivation, switching, and/or fallback operation. For example, the functionality/model selection may include decision(s) by the network (e.g., network initiated, or WTRU-initiated and requested to the network), and/or decision(s) by the WTRU (e.g., event-triggered as configured by the network, WTRU decision reported to the network, or WTRU-autonomous either with WTRU decision reported to the network or without it). LCM may also include functionality/model monitoring, Model update, WTRU capability, and/or data collection (e.g., for model training, for monitoring, for inference, etc.).

LCM can be functionality-based LCM or model-ID based LCM. In functionality-based LCM, network may indicate activation/deactivation/fallback/switching of AI/ML functionality via 3GPP signaling (e.g., RRC, MAC-CE, DCI). Models may not be identified at the Network, for example, and the WTRU may perform model-level LCM. The WTRU may have one AI/ML model for the functionality, or multiple AI/ML models for the functionality. In model-ID-based LCM, models may be identified at the Network, and Network/WTRU may activate/deactivate/select/switch individual AI/ML models via model ID. In the functionality-based LCM, the WTRU may choose the AIML model to use for a certain functionality (e.g., network decides for which functionalities the WTRU can use AIML based operation, and the WTRU chooses the AIML model to use).

In the model-ID based LCM, the network may explicitly control which particular model is used for a given AIML functionality. For example, the WTRU may provide details of AIML models and their capabilities, and the network may determine which model to activate for a particular functionality.

Examples described herein may be applicable to both model-ID based and functionality-based LCM. For example, the solutions described herein may be related to how the WTRU determines whether it has a model that is applicable for the indicated associated ID(s). For example, in the case of functionality-based LCM, the WTRU may be configured/requested to determine if a given functionality is valid/applicable, and the WTRU may make this determination from among the models available to the WTRU for a given functionality. For instance, the WTRU may consider the functionality applicable if at least one of the models at the WTRU is applicable. In another example, in the case of model-ID based LCM, the WTRU may be configured/requested by the network to determine whether a particular model is applicable.

Examples are described herein for the activation of an associated ID. In exemplary solutions described herein, the activation of an associated ID may indicate that the network is configuring the WTRU with an associated ID to use/consider and/or that the NW is indicating to the WTRU to determine if the WTRU has an AIML model or functionality that is applicable for that associated ID (e.g., and/or sub-associated ID(s)). In exemplary solutions described herein, references to whether an associated ID is applicable is meant to indicate whether the WTRU has an AIML functionality or model that is applicable for the associated ID and/or related sub-associated IDs.

In the case of functionality-based LCM, the WTRU may consider an associated ID applicable (or partially applicable) if there is at least one AIML model for that functionality that meets the applicability (or partial applicability) criteria, according to any of the solutions described herein.

In the case of model-ID based LCM, the WTRU may determine applicability (or partial applicability) of an associated ID for each AIML model for that functionality. Alternatively, the WTRU may be explicitly configured to perform the determination for a certain sub set of the AIML models. The WTRU may report the non-applicability, partial applicability or (e.g., full) applicability for each model or for a configured subset of the models. For example, the WTRU may send a list of the applicable models, a list of the non-applicable models, a list of the partial applicable models, etc., or a bitmap indicating which models are applicable or non-applicable. An order of bits in the bitmap may be, for example, based on a model ID sorting order agreed upon at the WTRU and the network, etc.

It is noted that an associated ID may be unique for a certain functionality or it may be shared among multiple functionalities. For the case where an associated ID can be applicable for more than one functionality, the WTRU may perform the determination of applicability for the associated ID for each respective functionality according to any of the solutions described herein. Further, the WTRU may indicate to the network which of the functionalities the associated ID is applicable (e.g., the list of the applicable functionalities, the list of non-applicable functionalities, the list of partially applicable functionalities, etc., or by using a bit map structure, similar to the one described above for the model ID based LCM, etc.).

In some solutions described herein, the WTRU may be configured to automatically (e.g., immediately) start applying the AIML model/functionality if the WTRU determines the AIML model/functionality to be applicable for a configured/indicated associated ID. In other solutions described herein, the WTRU may indicate the applicability of the AIML functionality/model to the network and wait for an indication from the network to activate the AIML functionality/model.

In one solution, the WTRU may be configured with a time duration and if the WTRU does not receive an indication from the network not to activate the concerned functionality/model (e.g., within the time duration after the reception of the associated ID activation command, within the time duration after the sending of the applicability or partial applicability indication, within the time duration after the reception of a lower layer acknowledgement (ACK) indicating the reception of the application indication by the network, etc.), then the WTRU may activate the concerned functionality/model (e.g., after the time duration lapses).

It is noted that some of the AIML functionalities described herein, such as beam management, are just illustrative examples, and are by no means limiting to the solutions described herein. For example, the proposed solutions can be used for any AI/ML functionality, if the functionality is to be used in a multi-TRP scenario and/or if the functionality is impacted depending on whether the WTRU operates in a single TRP or multi-TRP scenario.

The proposed solutions may also be equally valid to any other form of functionality that uses prediction that is not based on AIML (e.g. time series forecasting, interpolation methods, etc.), for example.

Thus, the solutions described herein may be agnostic to the kind of AIML model/technique used by the WTRU (e.g., algorithm used, mechanism such as neural network or what kind of neural network, depth and parameters/weights of the network, etc.), the origins of the model (e.g., WTRU vendor, operator, network vendor, etc.), and/or how/where the training of the model is performed (e.g., the input data used for the training, where the training is performed, if the training is performed offline or online, etc.). However, in at least some embodiments herein, it can be assumed that the model is trained based on historical observation of one or more WTRU actual measurements at different WTRUs, and/or network conditions (e.g., during certain time durations of the day, during certain days of the week, at different locations, different WTRU mobility patterns/speeds, under different network conditions that are visible to the WTRU such as frequency/bandwidth, etc., under different network configurations, which may be visible to the WTRU as a network configuration index provided by the network at the time of training or data collection for the training, etc.,).

The concept of sub-associated IDs described below is not limited to just one level of grouping, where an associated ID contains a group of sub-associated IDs. For example, solutions contemplated herein include solutions where a sub-associated ID may have related sub-associated IDs of its own (i.e., several layers of grouping of associated IDs). Additionally or alternatively, a sub-associated ID may belong to more than one associated ID. The terms functionality and procedure may be used interchangeably herein.

Examples are described herein for handling an associated ID and sub-associated ID(s) for multi-TRPs within a cell.

Hereafter, an associated ID may be interchangeably used with associated ID group, without departing from the scope of the present disclosure. Hereafter, a sub-associated ID may be interchangeably used with associated ID, without departing from the scope of the present disclosure. Hereafter, a sub-associated ID may be interchangeably used with inference configuration ID, inference related configuration ID, model ID, and/or functionality ID, without departing from the scope of the present disclosure.

In exemplary solutions, a WTRU may be configured, e.g., via one or more of RRC, MAC-CE, DCI and system information (e.g., MIB/SIB).

The WTRU may be configured with one or more associated IDs. The WTRU may receive an activation message of a subset (e.g., one associated ID) of the one or more associated IDs. Based on the activation message, the WTRU may activate the associated ID.

The WTRU may be configured with one or more sub-associated IDs. Each associated ID may be associated with a set of sub-associated IDs. For example, a subset of sub-associated IDs may be configured within an associated ID. In another example, an ID of the associated ID may be configured within a configuration associated with a sub-associated ID. Each sub-associated ID may be associated with TRP, functionality/parameter/characteristic, transmission scenario, configurations, and/or applicable AI/ML models.

Sub-associated ID(s) may be associated with TRP. For example, a first associated ID may be associated with a sub-associated ID for TRP #1 (e.g., based on a first set of RSs and/or SSBs) and a sub-associated ID for TRP #2 (e.g., based on a first set of RSs and/or SSBs). The WTRU may receive one or more signals and channels based on TRP #1 and/or TRP #2 when the first associated ID is activated. In another example, a second associated ID may be associated with a sub-associated ID for TRP #1 and a sub-associated ID for TRP #3. The WTRU may receive one or more signals and channels based on TRP #1 and/or TRP #3 when the first associated ID is activated.

Sub-associated ID(s) may be associated with functionality/parameter/characteristic. In a solution, a sub-associated ID may be associated with one or more of RS configurations (e.g., for CSI, for BM (e.g, RS configurations for Set A and/or Set B) and etc.), wireless channel (e.g., UMa, UMi and etc.), LOS probability, wireless traffic, number of UEs in the cell, etc. For example, a first associated ID may be associated with a sub-associated ID for a first functionality/parameter/characteristic and a sub-associated ID for a second functionality/parameter/characteristic. The WTRU may receive one or more signals and channels based on associated functionality/parameter/characteristic when the first associated ID is activated.

Sub-associated ID(s) may be associated with transmission scenario. In a solution, a sub-associated ID may be associated with one or more transmission scenarios. For example, a first associated ID may be associated with a first sub-associated ID for single point transmission from TRP #1, a second sub-associated ID for single point transmission from TRP #2 and a third sub-associated ID for joint transmission with same TB from TRP #1 and TRP #2, and a fourth sub-associated ID for joint transmission with different TBs from TRP #1 and TRP #2. The WTRU may receive one or more signals and channels based on associated transmission scenarios when the first associated ID is activated.

Sub-associated ID(s) may be associated with configurations. In a solution, a sub-associated ID may be associated with one or more of configurations (e.g., for inference and/or training). For example, a first associated ID may be associated with a sub-associated ID for a first configuration (e.g., training configuration) and a sub-associated ID for a second configuration (e.g., inference configuration). Each configuration may include one or more of RS measurement configuration (e.g., RS resources and/or resource sets), reporting configuration (e.g., CSI reporting and/or higher layer reporting), etc. In another example, an associated ID may be configured with, indicated with, associated with one or more sub-associated IDs, wherein each sub-associated ID may correspond to an inference configuration. A first sub-associated ID may be associated with a first inference configuration and a second sub-associated ID may be associated with a second inference configuration, and so forth, wherein a WTRU may determine applicable AI/ML model based on the indicated sub-associated ID and report whether the WTRU has applicable AI/ML model for the corresponding associated ID and sub-associated ID.

Sub-associated ID(s) may be associated with applicable AI/ML models. A sub-associated ID may correspond to or associated with one or more applicable AI/ML models (e.g., model IDs). For example, an associated ID may correspond to and/or associated with data collection related configuration (or information) for training and its one or more sub-associated IDs may be associated with one or more applicable AI/ML models (e.g., subset of AI/ML models applicable for a certain scenario or configuration). A WTRU may determine existence of the applicable AI/ML model or list of applicable AI/ML models based on the received or indicated sub-associated ID.

Sub-associated ID(s) may be associated with one or more sub-associated ID thresholds.

Sub-associated ID(s) may be associated with one or more configurations for performance evaluation.

The one or more configurations may include a RS configuration. In a solution, the WTRU may receive a configuration of one or more RS resources/resource sets for performance evaluation. For example, the WTRU may measure the one or more RS resources/resource sets and determine performance of AI/ML model (e.g., CSI prediction accuracy, beam prediction accuracy or positioning accuracy). The RS configuration may include a time offset between activation message of the associated IDs and a first RS transmission/reception of measurement for performance evaluation. In a solution, the WTRU may receive one or more activation messages for one or more associated IDs. Based on the activation messages, the wtru may determine a time domain position of RS resources based on the time offset. The RS configuration may include a time offset between gNB indication/confirmation and a first RS transmission/reception of measurement of measurement for performance evaluation. In a solution, the WTRU may receive one or more indications (e.g., indication of RS resource, triggering evaluation procedure, confirmation of UE indication, etc., from a gNB). Based on the one or more indications, the WTRU may determine a time domain position of RS resources based on the time offset. In a solution, the WTRU may receive one or more confirmations from a gNB (e.g., via receiving an indication from one or more of RRC, MAC CE, DCI or PDCCH in CORESET/search space associated with performance evaluation procedure).

The RS configuration may include gNB indication/confirmation resources. In a solution, the WTRU may determine a set of resources for gNB indication/confirmation (e.g., indication of RS resource, triggering evaluation procedure, confirmation of WTRU indication, etc., from a gNB).

The RS configuration may include number of RS transmission/measurement and/or measurement window. In a solution, the WTRU may receive/transmit during N number of RSs and/or M (e.g., symbols, slots, resources, resource sets, milliseconds (ms), etc.) measurement window for performance evaluation.

The RS configuration may include whether to report WTRU indication and/or UL resources for the WTRU indication if supported. In a solution, the WTRU may be configured whether to report WTRU indication. In a solution, the WTRU may be configured whether to indicate the evaluation result. The evaluation result may be one or more of evaluated metrics (e.g., prediction accuracy) and/or recommended one or more associated IDs and/or one or more sub-associated (e.g., to be used by a gNB). In a solution, the WTRU may indicate WTRU determination of applicability and/or determined mode of operation. For example, the WTRU may report the WTRU indication in one or more indicated reporting instances (e.g., based on indicated periodicity and/or offset via one or more of RRC, LPP, MAC CE and DCI one or more of RRC, LPP, MAC CE and DCI). If the WTRU indicates ‘not applicable’, the WTRU may apply non-AI/ML mode for associated procedures. If the WTRU indicates ‘applicable’, the WTRU may apply AI/ML mode for associated procedures. Alternatively, the WTRU may wait for an explicit indication from the network instructing it to apply or not apply the AI/ML procedure/functionality. If the WTRU indicates ‘partially applicable’, the WTRU may determine a mode of operation between AI/ML mode and non-AI/ML mode dynamically. In another example, if the WTRU indicates ‘partially applicable’, the WTRU may apply non-AI/ML mode. Alternatively, the WTRU may wait for an explicit indication from the network instructing it to apply or not apply the AI/ML procedure/functionality. The WTRU indication may be via one or more of RRC, MAC CE, PRACH, PUCCH and PUSCH. UL resources may be one or more of PUCCH resources, PUSCH resource and PRACH resources. Each UL resource may include frequency resources and time resources in one or more UL slots.

The one or more configurations for performance evaluation may also include evaluation types and/or evaluation parameters. In a solution, the WTRU may receive a configuration of one or more evaluation types and/or evaluation parameters. For example, the WTRU may receive one or more of CSI prediction accuracy, beam prediction accuracy or positioning accuracy. In another example, the WTRU may receive one or more of CSI, BM or positioning (e.g., as evaluation types or functionalities). Based on the configured evaluation types or functionalities, the WTRU may determine evaluation parameters and/or metrics for the evaluation.

The one or more configurations may include performance threshold. In a solution, the WTRU may receive a configuration of performance thresholds. The configuration may be for evaluation type and/or evaluation parameter. A type of the configured performance threshold may be determined based on the configured evaluation type and/or evaluation parameter. For example, for CSI, CSI prediction accuracy may be used. For beam prediction accuracy, best beam prediction accuracy (e.g., whether best-K beams are correctly predicted or not) may be used. For positioning, positioning accuracy may be used.

The one or more configurations may include UL resource for WTRU indication. In a solution, the WTRU may receive a configuration of one or more UL resources for WTRU indication. The configuration may be for evaluation type and/or evaluation parameter.

In a solution, the WTRU may indicate applicability/capability of the WTRU. The indication may be sent via RRC, MAC CE and DCI.

The WTRU may indicate WTRU applicability/capability based on one or more associated IDs. In a solution, the WTRU may indicate applicability/capability per associated ID. For example, the WTRU may indicate whether an associated ID is applicable or not. For example, the WTRU may indicate a first associated ID as applicable and a second associated ID as not applicable, etc. In a solution, the WTRU may indicate applicability/capability of the one or more sub-associated IDs for each AI/ML model and/or each functionality (e.g., CSI, BM or positioning). For example, the WTRU may indicate a first applicable subset of the one or more sub-associated IDs for a first AI/ML model and/or a first functionality and a second applicable subset of the one or more sub-associated IDs for a second AI/ML model and/or a second functionality.

The WTRU may indicate WTRU applicability/capability based on one or more sub-associated IDs. In a solution, the WTRU may indicate applicability/capability per sub-associated ID. For example, the WTRU may indicate whether a sub-associated ID is applicable or not. For example, the UE WTRU indicate a first sub-associated ID as applicable and a second sub-associated ID as not applicable, etc. In a solution, the WTRU may indicate applicability/capability of the one or more sub-associated IDs for each AI/ML model and/or each functionality (e.g., CSI, BM or positioning). For example, the WTRU may indicate a first applicable subset of the one or more sub-associated IDs for a first AI/ML model and/or a first functionality and a second applicable subset of the one or more sub-associated IDs for a second AI/ML model and/or a second functionality. In another solution, the WTRU may indicate applicability/capability of an indicated associated ID if the UE has at least one AI/ML model for all sub-associated IDs correspond to the associated ID. For example, an associated ID is configured with or correspond to N sub-associated IDs (e.g., N inference configurations), and the WTRU has or support AI/ML model for all sub-associated IDs (e.g., all inference configurations), the WTRU may indicate applicability/capability of the indicated associated ID. The sub-associated ID may be an inference configuration based on at least one of: set A and/or set B configuration for beam management, measurement RS configuration (e.g., CSI-RS periodicity) for beam management and/or CSI prediction, and/or CSI prediction window configurations (e.g., start window, length, number of prediction, prediction cycle, etc.) for CSI prediction.

The WTRU may indicate WTRU applicability/capability based on one or more TRPs. In a solution, the WTRU may indicate applicability/capability per TRP. For example, the WTRU may indicate whether a TRP is applicable.

The WTRU may indicate WTRU applicability/capability based on one or more functionalities/parameters/characteristics. In a solution, the WTRU may indicate applicability/capability per functionality/parameter/characteristic. For example, the WTRU may indicate whether a functionality/parameter/characteristic is applicable or not.

The WTRU may indicate WTRU applicability/capability based on one or more transmission scenarios. In a solution, the WTRU may indicate applicability/capability per transmission scenario. For example, the WTRU may indicate whether a transmission scenario is applicable.

In a solution, a WTRU may receive an activation message. The activation message may be based on one or more of RRC, LPP, MAC CE, and/or DCI.

The activation message may include one or more cell IDs. For example, the WTRU may receive an indication of one or more cell IDs to apply the activation.

The activation message may include a subset of associated IDs to be activated. The subset of associated IDs may be from the configured one or more associated IDs. In a solution, based on the indication, the WTRU may activate the indicated subset of associated IDs. In a solution, based on the indication, the WTRU may activate one or more associated IDs among the subset of associated IDs. For example, the WTRU may determine the one or more associated IDs based on number of applicable sub-associated IDs. For example, when a first associated ID and a second associated ID are indicated for the activation, if number of applicable sub-associated IDs of the first associated ID is greater than number of applicable sub-associated IDs of the second associated ID, then the WTRU may activate the first associated ID. If the number is identical, then the WTRU may determine an associated ID based on an associated ID number (e.g., lowest/highest associated ID).

The activation message may include a subset of sub-associated IDs to be activated. The subset of sub-associated IDs may be from the configured one or more sub-associated IDs. In a solution, based on the indication, the WTRU may activate the indicated subset of sub-associated IDs. In a solution, based on the indication, the WTRU may activate one or more associated IDs based on the indicated subset of sub-associated IDs. For example, the WTRU may determine the one or more associated IDs based on number of applicable sub-associated IDs. For example, when a first subset of sub-associated IDs and a second subset of sub-associated IDs are indicated for the activation, if number of applicable sub-associated IDs (e.g., among the indicated sub-associated IDs) associated with a first associated ID is greater than number of applicable sub-associated IDs (e.g., among the indicated sub-associated IDs) associated with a second associated ID, then the WTRU may activate the first associated ID. If the number is identical, then the WTRU may determine an associated ID based on an associated ID number (e.g., lowest/highest associated ID).

In a solution, the WTRU may determine applicability of a WTRU model (e.g., based on the configuration and the indicated capability/applicability). For example, the WTRU may determine the model is fully applicable if all sub-associated IDs associated with the indicated associated ID are applicable. In another example, the WTRU may determine the model is partially applicable if one or more of conditions are satisfied.

As a first example of the one or more conditions, if number of applicable sub-associated IDs of the indicated associated ID is greater than a sub-associated ID threshold, the WTRU may determine the associated ID is partially applicable. Otherwise, the model may be deemed not applicable.

As a second example of the one or more conditions, the WTRU may evaluate performance of the activated associated ID (e.g., by evaluating performance of AI/ML model prediction). For the evaluation, the WTRU may receive one or more RS resources. In an example, the one or more RS resources may be periodic/semi-persistent RS resources. The WTRU may receive an indication of measurement window for the periodic/semi-persistent RS resources. In another example, the one or more RS resources may be aperiodic RS resource. The WTRU may receive an indication of a RS resource configuration among configured RS resource configurations. The WTRU may measure the one or more RS resources in the indicated RS resource configuration.

As a third example of the one or more conditions, the WTRU may determine a quality parameter for performance evaluation. The quality parameter may be indicated (e.g., by a gNB via one or more of RRC, LPP, MAC CE, and/or DCI). The quality parameter may be determined based on a procedure/functionality associated with the activated associated ID.

As a fourth example of the one or more conditions, if the evaluated performance is greater than a performance threshold, the WTRU may determine the activated associated ID is partially applicable. Otherwise, the model may be deemed not applicable.

The WTRU may support the activated associated ID based on the determined applicability. For example, if the model is fully applicable or partially applicable, the WTRU may apply the associated ID for all the associated functionality/transmission scenarios. In another example, if the model is partially applicable, the WTRU may apply the associated ID only for the applicable functionality/transmission scenarios.

For example, the WTRU may be configured with two sets of configurations. For example, the WTRU may be configured with a first set of configurations for AI/ML model based procedure and a second set of configurations for non-AI/ML model based procedure. When the WTRU support a procedure associated with an associated ID, the WTRU may determine whether to support the procedure by applying the AI/ML functionality (e.g., based on the first set of configurations) or applying non-AI/ML functionality (e.g., based on the second set of configurations). For example, if the applicability is fully applicable, the WTRU may use a first set of configurations. If the applicability is not applicable, the WTRU may use a second set of configurations. If the applicability is partially applicable, the WTRU may determine to apply the first set of configurations or the second set of configurations dynamically. The WTRU may indicate the dynamic determination (e.g., to a gNB) explicitly or implicitly. For example, when the WTRU supports the explicit indication, the WTRU may indicate 1 bit indication (e.g., 0: non-AI/ML and 1: AI/ML) via one or more of MAC CE and DCI.

In a solution, the WTRU may identify an associated ID (e.g., for each functionality and/or WTRU operation) based on one or more of an explicit configuration or sub-associated IDs. As an example for explicit configuration, the WTRU may be indicated/configured with an associated ID. The indication/configuration may be via one or more of RRC, MAC CE, DCI and LPP. In case of RRC (e.g., for BM and/or CSI), CSI reporting related configuration may be used for configuring the associated ID. For example, an associated ID may be configured in one or more of CSI reporting configuration, RS resource set, RS resource, measurement configuration, etc.

As an example for identification based on sub-associated IDs, the WTRU may be configured with associated IDs with one or more sub-associated IDs. Each sub-associated ID may include one or more configurations of RS resource set for Set A, RS resource set for Set B, RS resource set for monitoring, reporting configuration, and/or transmission scenarios, etc. When the WTRU reports CSI reporting, the WTRU may identify an associated ID based on configurations of CSI reporting and configurations associated with an associated ID and sub-associated IDs. For example, the WTRU may be configured with a first associated ID with a first Set A configuration and/or a first Set B configuration and a second associated ID with a second Set A configuration and/or a second Set B configuration. The WTRU may also be configured with a first CSI report configuration with the first Set A configuration and/or the Set B configuration and a second CSI report configuration with the second Set A configuration and/or the second Set B configuration. When the WTRU reports CSI based on the first CSI report configuration, the WTRU may determine the first associated ID. When the WTRU reports CSI based on the second CSI report configuration, the WTRU may determine the second associated ID.

In a solution, if the WTRU determines/identifies an associated ID, the WTRU may apply the first set (e.g., for AI/ML functionality) of configurations (e.g., CSI reporting configuration). If the UE is not able to determine/identify an associated ID (e.g., no associated configurations/sub-associated IDs and/or number of associated configurations/sub-associated IDs<an evaluation threshold), the UE may apply the second set (e.g., for non-AI/ML functionality) of configurations (e.g., CSI reporting configuration).

In a solution, for supporting CSI (e.g., including beam information), the WTRU may indicate a used set of CSI report configurations via CRIs and/or SSBRIs. For example, the WTRU may determine applicability of the associated ID based on the indicated applicability. If the applicability is fully applicable, the WTRU may use a first set of report configuration (e.g., regardless of indicated CRIs/SSBRIs). If the applicability is not applicable, the WTRU may use a second set of CSI report configuration (e.g., regardless of indicated CRIs/SSBRIs). If the applicability is partially applicable, the WTRU may determine to apply the first set of CSI report configurations or the second set of CSI report configurations dynamically. When the dynamic determination is used, the WTRU may indicate whether the first CSI report configuration or the second CSI report configuration is used by indicating CRIs/SSBRIs.

TABLE 1
Example of applicability for transmission scenarios
and associated CRIs and corresponding CSI report
configuration based on the applicability:

| | | Indicated applicability | |
|---|---|---|---|
| | Associ- | by WTRU (e.g., via | |
| | ated | associated | CSI report |
| Transmission scenario | CRI(s) | sub-associated ID) | configuration |
| Transmission scenario | CRI #1 | Applicable | 1st set of CSI |
| #1 (e.g., DPS with | | | report |
| TRP #1) | | | configurations |
| Transmission scenario | CRI #2 | Applicable | 1st set of CSI |
| #2 (e.g., DPS with | | | report |
| TRP #2) | | | configurations |
| Transmission scenario | CRI #1 | Not applicable | 2nd set of CSI |
| #3 (e.g., JT with | and | | report |
| TRP #1 and TRP | CRI#2 | | configurations |
| #2) | | | |

For example, with reference to Table 1 above, the WTRU may indicate applicability of sub-associated ID #1 (e.g., transmission scenario #1) and sub-associated ID #2 (e.g., transmission scenario #2) as applicable and sub-associated ID #3 (e.g., transmission scenario #3) as non-applicable. In this case, the WTRU may determine the associated ID as partially applicable. Based on the determined applicability, when the UE reports CSI via 2 parts or 3 parts of information, the WTRU may indicate CRIs/SSBRIs in a first part or a second part. Based on the indicated CRIs/SSBRIs, information of a second part or a third part may be based on the first set of CSI report configurations or the second set of CSI report configurations. For example, if CRI #1 or CRI #2 is indicated in a first part, then information of a second part may be based on a first set of CSI report configurations. In another example, if both CRI #1 and CRI #2 are indicated in a first part, then information of a second part may be based on a second set of CSI report configurations.

In a solution, when the WTRU is activated with two or more associated IDs, the WTRU determination of applicability and application may be based on Joint determination of applicability and application of configurations.

In an example, the WTRU may determine an applicability for the whole activated associated IDs based on number of applicable sub-associated IDs. If number of applicable sub-associated IDs of the whole activated associated IDs is greater than a sub-associated ID threshold, the WTRU may determine the whole activated associated IDs are partially applicable. Otherwise, the whole activated associated IDs may be deemed not applicable. If average/median number of applicable sub-associated IDs of the whole activated associated IDs is greater than a sub-associated ID threshold, the WTRU may determine the whole activated associated IDs are partially applicable. Otherwise, the whole activated associated IDs may be deemed not applicable. If number of applicable sub-associated IDs of an activated associated IDs is greater than a sub-associated ID threshold, the WTRU may determine the whole activated associated IDs are partially applicable. Otherwise, the whole activated associated IDs may be not applicable. The activated associated ID may be an activated associated ID with max/min number of applicable sub-associated IDs.

Alternatively or additionally, the WTRU determination of applicability and application may be based on performance evaluation. For example, the WTRU may evaluate performance of the activated associated IDs (e.g., by evaluating performance of AI/ML model prediction). The performance may be one or more of average, minimum, maximum, add median of performance of the activated associated IDs. If the performance is greater than a performance threshold, the WTRU may determine the associated IDs are partially applicable. Otherwise, the associated IDs may be deemed not applicable.

The WTRU determination of applicability and application may be further based on a separate determination of applicability. In an example, the WTRU may determine an applicability for each associated ID and determine a mode of operation for each associated ID.

Examples are described herein for life cycle management of sub-associated IDs. Example aspects related to the number of sub associated IDs that are applicable are described herein. In one solution, the WTRU may be configured with a certain number of the sub-associated IDs (e.g., threshold_1) within an associated ID that must be applicable to consider a certain associated ID as applicable. For example, if an associated ID contains 6 sub associated IDs and the WTRU is configured with a threshold_1 value of 4, the WTRU may consider the associated ID applicable if the WTRU has an AIML model for the functionality that supports at least 4 of the sub-associated IDs.

In one solution, the threshold is specified as a percentage value. For example, if threshold_1 is set to be 80% and the associated ID has 10 sub associated IDs, the WTRU may consider the associated ID to be applicable if the WTRU has an AIML model that supports at least 8 of the sub-associated IDs.

In one solution, the WTRU may be configured with two thresholds, a lower threshold and an upper threshold (e.g, threshold_low and threshold_high). In an example, if the number of supported sub-associated IDs are below threshold_low, the WTRU may consider the associated ID not applicable. In an example, if the number of supported sub-associated IDs are between threshold_low and threshold_high, it will consider the associated ID partially applicable. In an example, if the number of support sub-associated IDs are above threshold_high, the WTRU may consider the associated ID as (e.g., fully) applicable. The threshold_low and threshold_high may be configured to be percentage values. Alternatively, one of the thresholds is configured as a percentage value while the other is an actual value (e.g., threshold_low=3, threshold_high=90%).

In one solution, the WTRU may consider a certain sub-associated IDs as applicable (e.g., essential and/or must be applicable regardless of the specified threshold(s) discussed above for considering the associated ID applicable or partially applicable). For example, associated ID X may have 10 sub-associated IDs (e.g., a to 1), and sub-associated IDs c and g may be configured as ‘essential.’ Additionally, the WTRU may be configured with a threshold_low of 5 and threshold_high of 8. Thus, in this the WTRU will determine applicability as follows. If sub-associated IDs c and g are not applicable (i.e., regardless of how many of the other sub-associated IDs are applicable), the associated ID is considered as not applicable. Otherwise (i.e., c and g are applicable), if less than 3 sub-associated IDs (other than c and g) are applicable, the associated ID is considered as not applicable. If more than 3 but less than 6 other sub-associated IDs are applicable, the associated ID is considered as partially applicable. If 6 or more other sub-associated IDs are applicable, the associated ID is considered as (e.g., fully) applicable.

In one solution, the essential sub-associated IDs may be explicitly configured (E.g., WTRU configured to consider sub-associated IDs a and b as essential). In one solution, the essential sub-associated IDs may be implicitly configured. For example, the sub-associated IDs within a given associated ID may be indexed numerically, and the WTRU may consider the first n of these sub-associated IDs to be essential, where n is a configurable parameter by the network).

The thresholds discussed above can be the same for multiple (e.g., or all) associated IDs, or one or more (e.g., or each) associated ID may have its own associated threshold value(s). In one solution, if the WTRU has more than one AIML model for a given AIML functionality that is partially applicable (e.g., and none that is fully applicable) for the indicated/configured associated ID, according to any of the solutions above, the WTRU may consider the AIML model that fulfills the partial applicability the most to be the model that is to be used/activated. For example, if the WTRU has determined that it has model A and B that are partially applicable, but model A is applicable for more sub-associated IDs than model B, then the WTRU may choose to activate model A.

Examples are described herein for performance related information in the request. In one solution, the WTRU may be configured with a performance evaluation criterion (e.g., a KPI and threshold value) that must be fulfilled to consider an AIML model to be applicable for a given associated ID (and related sub-associated IDs). In one example, this performance evaluation is performed if the WTRU has determined that the associated ID is partially applicable according to any of the solutions above. In another example, this performance evaluation is performed if the WTRU has determined the associated ID is not applicable according to any of the solutions above.

In one solution, the WTRU may be provided with a time duration to do the performance evaluation.

In one solution, the WTRU is provided with more than one KPI and related threshold. For example, for the beam management functionality, the WTRU may be provided with a configuration that includes KPI 1 (e.g., beam prediction accuracy, threshold 1), KPI2 (e.g., L1-RSRP difference between measured and predicted beams, threshold 2), etc.

In one solution, if the WTRU is provided with more than one KPI and related thresholds, the WTRU may be configured to consider the associated ID as applicable if all the thresholds for all the KPIs are fulfilled.

In one solution, if the WTRU is provided with more than one KPI and related thresholds, and if one of the KPIs fulfills the threshold associated with it, the WTRU may consider the associated ID as applicable.

In one solution, a certain number or percentage of the KPIs have to fulfill their corresponding thresholds for the WTRU to consider the associated ID as applicable.

In one solution, the WTRU may be provided with different evaluation time duration for the different KPIs.

In one solution, the WTRU may be configured to perform the performance evaluation even if the WTRU has determined the functionality to be applicable based on the comparison of the supported sub-associated IDs according to any of the solutions above. That is, even if the WTRU has checked the consistency of the training data used for the AIML model and the current network side additional conditions, the WTRU may be configured to perform the performance evaluation temporarily before doing a final determination of the applicability of the AIML model.

In one solution, the WTRU is provided with different evaluation time durations, KPIs, thresholds, etc. for the different levels of applicability that was determined based on associated IDs and sub-associated IDs according to any of the solutions above. For example, the WTRU may be configured to do the following performance evaluation for a given associated ID. If the WTRU determines that the associated ID was is not applicable (e.g., less than the required sub-associated IDs for partial applicability are determined to be applicable), the WTRU may perform the performance evaluation for 10 seconds and may consider the associated ID applicable if the thresholds for the KPI for the non-applicable case are fulfilled. If the WTRU determines that the associated ID is partially applicable (e.g., more than the required sub-associated IDs for partial-applicability but less the required for full-applicability are determined to be applicable), the WTRU may perform the performance evaluation for 5 seconds and consider the associated ID applicable if the thresholds for the KPI for the partially applicable case are fulfilled. If the WTRU determines that the associated ID was determined to be applicable (e.g., more than required sub-associated IDs for full-applicability are determined to be applicable), the WTRU may perform performance evaluation for 1 seconds and consider the associated ID finally applicable if the thresholds for the KPI for the fully applicable case are fulfilled.

In one solution, if the WTRU has more than one AIML model for a given AIML functionality that is partially applicable for the indicated/configured associated ID, according to any of the solutions above, the WTRU may be configured to perform the performance evaluation of these partially-applicable models in parallel (e.g. or in sequence) and choose the one that has the better performance (e.g., among the ones that fulfill the configured KPI(s) and related threshold(s)).

In one solution, the performance level(s) to be checked may be signalled to the WTRU prior to the activation of the associated ID activation indication (e.g., in a separate dedicated or broadcasted message, specified in 3GPP standards as a minimum requirement for a functionality to be considered applicable, etc.)

In one solution, if the performance levels(s) are included in the associated ID activation message and/or prior to the reception of the activation message, the WTRU may be configured to consider only the ones in the activation message (i.e., the information in the activation message overrides the previous ones the WTRU has been provided with). In another solution, the performance levels provided prior to the activation message will be considered.

In one solution, if the performance levels(s) are included in the activation message and also prior to the activation message, the WTRU may be configured to consider a union of the two, assuming they are not referring to the same metric (e.g., in the activation message performance level related to beam accuracy is provided while in the previous message performance level related to L1 RSRP difference was provided, and WTRU may consider both).

The WTRU may receive a configuration of one or more associated IDs and one or more sub-associated IDs. Each associated ID may be associated with a set of sub-associated IDs. Each sub-associated ID may represent one of each TRP, functionality (e.g., reference signal (RS) configuration, channel, gNB traffic, etc.), and/or transmission scenario. As an example of TRP specific associated IDs, a first associated ID (e.g., associated ID #1) may be associated with a sub-associated ID for a first TRP (e.g., TRP #1) and a sub-associated ID for a second TRP (e.g., TRP #2). In this example, a second associated ID (e.g., associated ID #2) may be associated with a sub-associated ID for the first TRP (e.g., TRP #1) and a sub-associated ID for a third TRP (e.g., TRP #3).

Examples are described herein for determination of applicability of AI/ML models based on sub-associated IDs. The WTRU may indicate WTRU applicability and/or capability of the one or more sub-associated IDs. For example, a first sub-associated ID (e.g., ID #1) may be indicated as being applicable, and a second sub-associated ID (e.g., ID #2) may be indicated as not applicable. In some examples, the applicability of a given sub-associated ID may be updated (e.g., changed) dynamically.

The WTRU may receive an activation message of an associated ID.

The WTRU may determine applicability of a WTRU model based on the configuration. For example, the WTRU may determine the model is fully applicable if all sub-associated IDs associated with the indicated associated ID are applicable. As another example, the WTRU may determine the model is partially applicable if one or more conditions are satisfied.

A first example condition may be if number of applicable sub-associated IDs of the indicated associated ID is greater than a sub-associated ID threshold, then the WTRU may determine the model is partially applicable. Otherwise, the model may be deemed not applicable.

A second example condition may include the WTRU evaluating performance of the AI/ML model (e.g., by evaluating performance of AI/ML model prediction). If the performance is greater than a performance threshold, the WTRU may determine the model is partially applicable. Otherwise, the model may be deemed not applicable. Alternatively or additionally, the WTRU may receive a configuration related with evaluation (e.g., one or more evaluation types and/or evaluation parameters) such as RS config/duration/timer.

The WTRU may support AI/ML model based on the determined applicability. For example, if the model is fully applicable (or partially applicable), the WTRU may apply the AI/ML model for all the associated functionality/transmission scenarios. Alternatively or additionally, if the model is partially applicable, the WTRU may apply the AI/ML model only for the applicable functionality/transmission scenario(s) (e.g., switching between AI/ML and non-AI/ML). If the model is not applicable, the WTRU may apply non-AI/ML mode.

Advantageously, the proposed solution described herein may enable the WTRU to identify whether a given scenario is fully applicable, partially applicable, and/or not applicable based on given sub-associated IDs and supported AI/ML model(s) accordingly.

Examples are described herein for life cycle management procedure based on sub-associated IDs. A WTRU may evaluate performance of sub-associated IDs associated with an activated associated ID and determines required recovery procedure based on the evaluated performance.

The WTRU receives a configuration of one or more associated IDs and one or more sub-associated IDs. Each associated ID may be associated with a set of sub-associated IDs. Each sub-associated ID may represent TRP, functionality (e.g., RS configuration, channel, gNB traffic and etc.), and/or transmission scenario. For example, associated ID #1 may have a sub-associated ID for TRP #1 and a sub-associated ID for TRP #2, and associated ID #2 may have a sub-associated ID for TRP #1 and a sub-associated ID for TRP #3

The WTRU may receive an activation message of an associated ID. The WTRU may evaluate performance of sub-associated IDs associated with the associated ID. If number of sub-associated IDs is less than a performance threshold and the performance threshold is higher than a first sub-associated ID threshold, the WTRU may indicate failed sub-associated IDs (e.g., the WTRU may indicate a new candidate sub-associated IDs instead). The WTRU may continue operation of the other sub-associated IDs. If number of sub-associated IDs is less than the performance threshold and the performance threshold is higher than a second sub-associated ID threshold (e.g., all sub-associated IDs fail) or if the failed sub-associated ID is a reference sub-associated ID, the WTRU applies non-AI/ML mode and recovery procedure (potentially including a request of change for an associated ID).

Advantageously, this proposed solution may allow the WTRU to monitor and recover AI/ML model efficiently based on given sub-associated IDs.

1. A Wireless Transmit/Receive Unit (WTRU) comprising:
a processor configured to:
receive configuration information indicating of an associated identifier (ID) and a set of sub-associated IDs related to the associated ID, wherein the associated ID represents a network condition, wherein each of the set of sub-associated IDs represents at least one of a functionality or a transmission scenario;
determine applicability of the associated ID based on the configuration information, wherein the determined applicability corresponds to full applicability based on the associated ID being applicable for each of the set of sub-associated IDs, wherein the applicability corresponds to partial applicability based on the associated ID being applicable for at least one of the set of sub-associated IDs; and
apply the associated ID to perform at least one of the functionality or the transmission scenario based on the determined applicability.

2. The WTRU of claim 1, wherein the processor is further configured to:
receive an activation message of the associated ID; and
determine the applicability in response to receipt of the activation message.

3. The WTRU of claim 1, wherein a first sub-associated ID of the set of sub-associated IDs represents the network condition for a first transmit-receive-point (TRP) and a second sub-associated ID of the set of sub-associated IDs represents the network condition for a second TRP.

4. The WTRU of claim 1, wherein the configuration information includes an indication of a second associated ID and a second set of sub-associated IDs.

5. The WTRU of claim 1, wherein the processor is further configured to:
send an indication of an applicability of one or more sub-associated IDs with respect to one or more artificial intelligence/machine learning (AIML) models at the WTRU.

6. The WTRU of claim 1, wherein the processor is further configured to:
determine that the associated ID is partially applicable based on a number of applicable sub-associated IDs being greater than a threshold.

7. The WTRU of claim 1, wherein the processor is further configured to:
evaluate performance of an artificial intelligence/machine learning (AIML) model with respect to the set of sub-associated IDs; and
determine that the AIML model is applicable with respect to a first sub-associated ID based on the evaluated performance being greater than a performance threshold.

8. The WTRU of claim 1, wherein the processor is further configured to:
apply an artificial intelligence/machine learning (AIML) model for the functionality and the transmission scenario based on the applicability corresponding to full applicability; and
apply the AIML model for one of the functionality or the transmission scenario based on the applicability corresponding to partial applicability.

9. The WTRU of claim 1, wherein a first sub-associated ID of the set of sub-associated IDs represents a first configuration for training an artificial intelligence/machine learning (AIML) model and a second sub-associated ID of the set of sub-associated IDs represents a second configuration for inference using the AIML model.

10. The WTRU of claim 1, wherein a first sub-associated ID of the set of sub-associated IDs corresponds to a first artificial intelligence/machine learning (AIML) model, wherein a second sub-associated ID of the set of sub-associated IDs corresponds to a second AIML model at the WTRU.

11. A method performed by a Wireless Transmit/Receive Unit (WTRU), the method comprising:
receiving configuration information indicating an associated identifier (ID) and a set of sub-associated IDs related to the associated ID, wherein the associated ID represents a network condition, wherein each of the set of sub-associated IDs represents at least one of a functionality or a transmission scenario;
determining applicability of the associated ID based on the configuration information, wherein the determined applicability corresponds to full applicability based on the associated ID being applicable for each of the set of sub-associated IDs, wherein the applicability corresponds to partial applicability based on the associated ID being applicable for at least one of the set of sub-associated IDs; and
applying the associated ID to perform at least one of the functionality or the transmission scenario based on the determined applicability.

12. The method of claim 11, further comprising:
receiving an activation message of the associated ID; and
determining the applicability in response to receipt of the activation message.

13. The method of claim 11, wherein a first sub-associated ID of the set of sub-associated IDs represents the network condition for a first transmit-receive-point (TRP) and a second sub-associated ID of the set of sub-associated IDs represents the network condition for a second TRP.

14. The method of claim 11 wherein the configuration information includes an indication of a second associated ID and a second set of sub-associated IDs.

15. The method of claim 11, further comprising:
sending an indication of an applicability of one or more sub-associated IDs with respect to one or more artificial intelligence/machine learning (AIML) models at the WTRU.

16. The method of claim 11, further comprising:
determining that the associated ID is partially applicable based on a number of applicable sub-associated IDs being greater than a sub-associated ID threshold.

17. The method of claim 11, further comprising:
evaluating performance of an artificial intelligence/machine learning (AIML) model with respect to the set of sub-associated IDs; and
determining that the AIML model is applicable with respect to a first sub-associated ID based on the evaluated performance being greater than a performance threshold.

18. The method of claim 11, further comprising:
applying an artificial intelligence/machine learning (AIML) model for the functionality and the transmission scenario based on the applicability corresponding to full applicability; and
applying the AIML model for one of the functionality or the transmission scenario based on the applicability corresponding to partial applicability.

19. The method of claim 11, wherein a first sub-associated ID of the set of sub-associated IDs represents a first configuration for training an artificial intelligence/machine learning (AIML) model and a second sub-associated ID of the set of sub-associated IDs represents a second configuration for inference using the AIML model.

20. The method of claim 11, wherein a first sub-associated ID of the set of sub-associated IDs corresponds to a first artificial intelligence/machine learning (AIML) model, wherein a second sub-associated ID of the set of sub-associated IDs corresponds to a second AIML model at the WTRU.
